(19) United States
(12) Patent Application Publication
(10) Pub. No.: US 2015/0256885 A1
(43) Pub. Date: Sep. 10, 2015

(54) METHOD FOR DETERMINING CONTENT FOR A PERSONAL CHANNEL

(71) Applicant: THOMSON LICENSING, Issy de Moulineau (FR)

(72) Inventors: Ashwin S. KASHYAP, Santa Clara, CA (US); David Anthony CAMPANA, Kirkland, WA (US); Dekai LI, San Jose, CA (US); Avinash SRIDHAR, Cranbury, NJ (US)

(21) Appl. No.: 14/721,771

(22) Filed: May 26, 2015

Related U.S. Application Data
(63) Continuation of application No. 12/932,245, filed on Feb. 22, 2011, now abandoned.
(60) Provisional application No. 61/306,936, filed on Feb. 22, 2010.

(51) Int. Cl. H04N 21/466; H04N 21/4147; H04N 21/462; H04N 21/482; H04N 21/45; H04N 21/442

(52) U.S. Cl. CPC H04N 21/4668; H04N 21/4532; H04N 21/44222; H04N 21/4622; H04N 21/4667; H04N 21/4826; H04N 21/4147

(57) ABSTRACT

Creating a listing of suggested content and programming for a virtual channel is performed by generating rankings of previously viewed or accessed content. The method determines whether such content is either cyclical in nature as being related to a series or if such content is broadcasted less frequently. Once such rankings are determined, the listings of suggested (other) content will have a number of entries per time segment which represent the highest ranked suggested per time segment

This application is a continuation of U.S. patent application Ser. No. 12/932,245, filed on Feb. 22, 2011, which claims priority of U.S. Provisional Patent Application Ser. No. 61/306,936, filed on Feb. 22, 2010.

### FIELD OF THE INVENTION

The field of the invention involves the selection of media content, specifically the selection of media content which is automatically selected in view of a user's personal preferences.

### BACKGROUND OF THE INVENTION

A user watching programming using a video consumption device such as a set top box, personal video recorder, personal computer and the like, typically has to select the programming that the user wants to watch. For example, a user uses an electronic programming guide to select programming that is being broadcasted, where hundreds of channels can be made available at the same time. For a user, such a multitude of programming options makes it likely that the user will change channels multiple times before the user finds desirable programming to be viewed. That is, a user does not want to refer to a program guide to find programming, select such programming, and repeat this process over and over until the user finds video content to watch.

### SUMMARY OF THE INVENTION

A method for creating a listing of suggested content and programming for a virtual channel described. The virtual channel suggested programming is generated from rankings of previously viewed or accessed content. The method determines whether such content is either cyclical in nature as being related to a series or if such content is broadcasted less frequently. Once such rankings are determined, the listings of suggested content will have a number of entries per time segment which represent the highest ranked suggested content per time segment.

### DETAIL DESCRIPTION OF THE DRAWINGS

These and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 shows a block diagram of an embodiment of a system for delivering content to a home or end user.

FIG. 2 presents a block diagram of a system that presents an arrangement of media servers, online social networks, and consuming devices for consuming media.

FIG. 3 shows a block diagram of an embodiment of a set top box/digital video recorder.

FIG. 4 discloses an embodiment of content selections for a virtual channel shown in the form of an electronic program guide;

FIG. 5 represents a flow diagram for a method for determining personalization metrics;

FIG. 6 represents a flow chart diagram for determining the content selected for a virtual channel for a particular time segment; and

FIG. 7 discloses a method for determining and displaying ranked programming.

### DETAILED DESCRIPTION OF THE INVENTION

It should be understood that the elements shown in the figures can be implemented in various forms of hardware, software or combinations thereof. Preferably, these elements are implemented in a combination of hardware and software on one or more appropriately programmed general-purpose devices, which can include a processor, memory and input/output interfaces. Herein, the phrase “coupled” is defined to mean directly connected to or indirectly connected with through one or more intermediate components or signal paths. Such intermediate components can include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes that can be substantially represented in computer readable media and so executed by a computer or processor, whether or not such computer or processor is explicitly shown. The computer readable media and code written on can be implemented in a transitory state (signal) and a non-transitory state (e.g., on a tangible medium such as CD-ROM, DVD, Blu-Ray, Hard Drive, flash card, or other type of tangible storage medium).

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read only memory (“ROM”) for storing software, random access memory (“RAM”), and nonvolatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The various embodiments described herein present a virtual channel which has various content/program and media services selected for a user in view of preferences that are formed based on information including information that a user has specified that the user has interested in and from prior content selections. The embodiments presented herein provide a simple way for a user to “tune” to a single channel and be provided with various media content from different sources (such as broadcast, internet based sources, personal video recorded stored content, disc based content (DVD/Blu-Ray), and the like). The various sources of content are not meant to be limiting and can involve multiple sources from which content can be selected and therefore provided to a user.

Systems for delivering various types of content to a user and the processing of such content will be described,

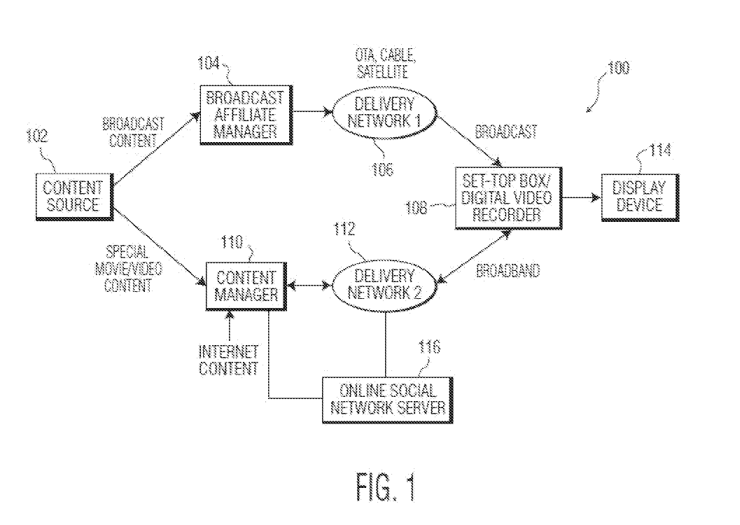

With reference to FIG. 1, a block diagram of an embodiment of a system 100 for delivering content to a home or end user is shown. The content originates from a content source 102, such as a movie studio or production house. The content can be supplied in at least one of two forms. One form can be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager can collect and store the content, and can schedule delivery of the content over a deliver network, shown as delivery network 1 (106). Delivery network 1 (106) can include satellite link transmission from a national center to one or more regional or local centers. Delivery network 1 (106) can also include local content delivery using local delivery systems such as over the air broadcast, satellite broadcast, cable broadcast or from an external network via IP. The locally delivered content is provided to a user's set top box/digital video recorder (DVR) 108 in a user's home, where the content will subsequently be included in the body of available content that can be searched by the user.

A second form of content is referred to as special content. Special content can include content delivered as premium viewing, pay-per-view, or other content not otherwise provided to the broadcast affiliate manager. In many cases, the special content can be content requested by the user. The special content can be delivered to a content manager 110. The content manager 110 can be a service provider, such as an Internet website, affiliated, for instance, with a content provider, broadcast service, or delivery network service. The content manager 110 can also incorporate Internet content into the delivery system, or explicitly into the search only such that content can be searched that has not yet been delivered to the user's set top box/digital video recorder 108. The content manager 110 can deliver the content to the user's set top box/digital video recorder 108 over a separate delivery network, delivery network 2 (112). Delivery network 2 (112) can include high-speed broadband Internet type communications systems. It is important to note that the content from the broadcast affiliate manager 104 can also be delivered using all or parts of delivery network 2 (112) and content from the content manager 110 can be delivered using all or parts of Delivery network 1 (106). In addition, the user can also obtain content directly from the Internet via delivery network 2 (112) without necessarily having the content managed by the content manager 110. In addition, the scope of the search goes beyond available content to content that can be broadcast or made available in the future.

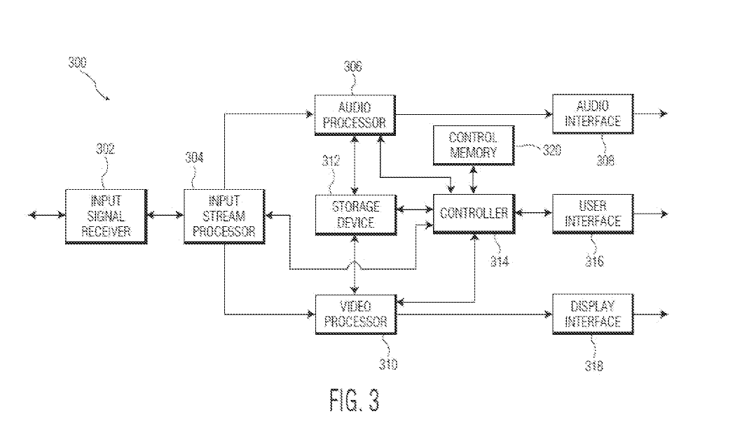

The set top box/digital video recorder 108 can receive different types of content from one or both of delivery network 1 and delivery network 2. The set top box/digital video recorder 108 processes the content, and provides a separation of the content based on user preferences and commands. The set top box/digital video recorder can also include a storage device, such as a hard drive or optical disk drive, for recording and playing back audio and video content. Further details of the operation of the set top box/digital video recorder 108 and features associated with playing back stored content will be described below in relation to FIG. 3. The processed content is provided to a display device 114. The display device 114 can be a conventional 2-D type display or can alternatively be an advanced 3-D display. It should be appreciated that other devices having display capabilities such as wireless phones, PDAs, computers, gaming platforms, remote controls, multi-media players, or the like, can employ the teachings of the present disclosure and are considered within the scope of the present disclosure.

Delivery network 2 is coupled to an online social network 116 which represents a website or server in which provides a social networking function. For instance, a user operating set top box 108 can access the online social network 116 to access electronic messages from other users, check into recommendations made by other users for content choices, see pictures posted by other users, refer to other websites that are available through the “Internet Content” path.

Online social network server 116 can also be connected with content manager 110 where information can be exchanged between both elements. Media that is selected for viewing on set top box 108 via content manager 110 can be referred to in an electronic message for online social networking 116 from this connection. This message can be posted to the status information of the consuming user who is viewing the media on set top box 108. That is, a user using set top box 108 can instruct that a command be issued from content manager 110 that indicates information such as the <<ASSETID>>, <<ASSETTYPE>>, and <<LOCATION>> of a particular media asset which can be in a message to online social networking server 116 listed in <<SERVICE ID>> for a particular user identified by a particular field <<USERNAME>> is used to identify a user. The identifier can be an e-mail address, hash, alphanumeric sequence, and the like.

Content manager 110 sends this information to the indicated social networking server 116 listed in the <<SERVICE ID>>, where an electronic message for &USERNAME has the information comporting to the <<ASSETID>>, <<ASSETTYPE>>, and <<LOCATION>> of the media asset posted to status information of the user. Other users who can access the social networking server 116 can read the status information of the consuming user to see what media the consuming user has viewed.

Examples of the information of such fields are described below.

TABLE 1

| | |
|---|---|
| <<SERVICE ID> | This field represents a particular |
| | social networking service or other |
| | messaging medium that can be used. |
| &FACEBOOK | Facebook |
| &TWITTER | Twitter |
| &LINKEDIN | Linked-In |
| &FLICKER | Flicker Photo Sharing |
| &QZONE | Q-Zone |
| &MYSPACE | MySpace |
| &BEBO | Bebo |
| &USERNAME | User Name of a person using a social |
| | networking service |

TABLE 2

| | |
|---|---|
| <<ASSETID>> | This field represents the “name” |
| | of the media asset which is |
| | used for identifying the particular asset |
| &UUID | A universal unique identifier that is |
| | used for the media asset. This can be a unique |
| | MD5, SHA1 , other type of hash, |
| | or other type of identifier |
| &NAME | A text name for the media asset |
| &TIME | Time that a media asset is being accessed. |
| | This information can |
| | be seconds, hours, days, day of the week, |
| | date, and other time related information |
| &ASSETCOMPLETE | The % of completion in the consumption |
| | of an asset |

The term media asset (as described below for TABLE 3) can be: a video based media, an audio based media, a television show, a movie, an interactive service, a video game, a HTML based web page, a video on demand, an audio/video broadcast, a radio program, advertisement, a podcast, and the like.

TABLE 3

| | |
|---|---|
| <<ASSETTYPE> | This field represents the type of asset |
| | that is being communicated to a |
| | user of a social networking website. |
| &VIDEO | Video based asset |
| &AUDIO | Audio based asset |
| &PHOTO | Photo based asset |
| &TELEVISION | Television show asset which can be audio, |
| | video, or a combination of both |
| &MOVIE | Movie asset which can be audio, |
| | video, or a combination of both |
| &HTML | HTML based web page |
| &PREVIEW | Trailer which can be audio, video, |
| | or a combination of both |
| &ADMOVE | Advertisement asset-expected to be video |
| | and/or audio based such as a flash animation, |
| | H.264 video, SVC video, and the like. |
| &ADSTAT | Advertisement asset-expected to be a |
| | static image such as a JPG, PNG, |
| | and the like that can be used as a banner ad |
| &TEXT | Text Message |
| &RADIO | An audio asset that comes from |
| | terrestrial and/or satellite radio |
| &GAME | Game asset. |
| &INTERACTIVE | An interactive based media asset |
| &PODCAST | Podcast that is audio, video, |
| | or a combination of both |
| &APPLICATION | Indicates that a user utilized a particular type |
| | of application or accessed a particular service |

TABLE 4

| | |
|---|---|
| <<LOCATION> | This field represents the location of |
| | a particular media asset |
| &URL | The location of a media asset expressed as a |
| | uniform resource locator and/or IP address |
| &PATH\PATH . . . | The location of a media asset expressed as a |
| | particular local or remote path which can |
| | have multiple subdirectories. |
| &REMOTE | The location of a media asset in a remote |
| | location which would be specified by text |
| | after the remote attribute. |
| &LOCAL | The location of a media asset in a local |
| | location which would be specified by text |
| | after the remote attribute. |
| &BROADCAST | The location being a broadcast source such |
| | as satellite, broadcast television channel, |
| | cable channel, radio station, and the like |
| &BROADCASTID | The identifier of the broadcast channel used for |
| | transmitting a media asset, and the like |
| &SERVICE | Identification of a service for which a media |
| | asset can originate (as a content source or content |
| | provider). Examples of different services include |
| | HULU, NETFLIX, VUDU, and the like. |

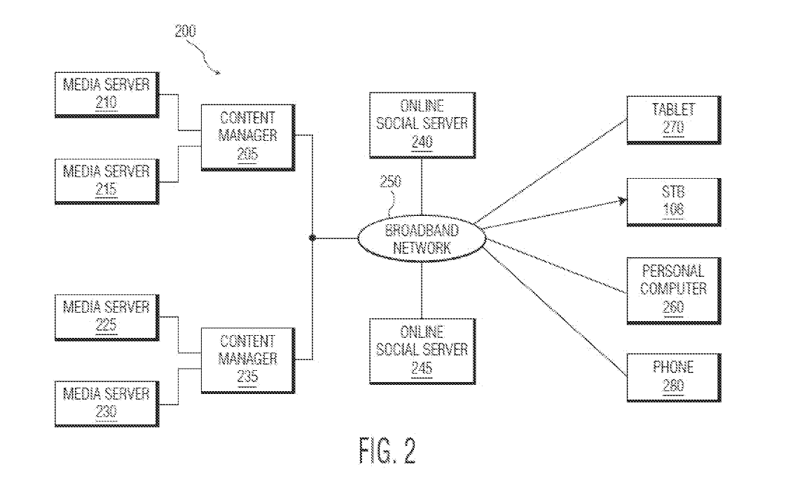

FIG. 2 presents a block diagram of a system 200 that presents an arrangement of media servers, online social networks, and consuming devices for consuming media. Media servers 210, 215, 225, and 230 represent media servers where media is stored. Such media servers can be a hard drive, a plurality of hard drives, a server farm, a disc based storage device, and other type of mass storage device that is used for the delivery of media over a broadband network.

Media servers 210 and 215 are controlled by content manager 205. Likewise, media server 225 and 230 are controlled by content manager 235. In order to access the content on a media server, a user operating a consumption device such as STB 108, personal computer 260, table 270, and phone 280 can have a paid subscription for such content. The subscription can be managed through an arrangement with the content manager 235. For example, content manager 235 can be a service provider and a user who operates STB 108 has a subscription to programming from a movie channel and to a music subscription service where music can be transmitted to the user over broadband network 250. Content manager 235 manages the storage and delivery of the content that is delivered to STB 108. Likewise, other subscriptions can exist for other devices such as personal computer 260, tablet 270, and phone 280, and the like. It is noted that the subscriptions available through content manager 205 and 235 can overlap, where for example; the content comporting for a particular movie studio such as DISNEY can be available through both content managers. Likewise, both content managers 205 and 235 can have differences in available content, as well, for example content manager 205 can have sports programming from ESPN while content manager 235 makes available content that is from FOXSPORTS. Content managers 205 and 235 can also be content providers such as NETFLIX, HULU, and the like who provide media assets where a user subscribes to such a content provider. An alternative name for such types of content providers is the term over the top service provider (OTT) which can be delivered “on top of” another service. For example, considering FIG. 1 content manager 110 provides internet access to a user operating set top box 108. An over the top service from content manager 205/235 (as in FIG. 2) can be delivered through the “internet content” connection, from content source 102, and the like.

By a content manager 205, 235, a subscription is not the only way that content can be authorized. Some content can be accessed freely through a content manager 205, 235 where the content manager does not charge any money for content to be accessed. Content manager 205, 235 can also charge for other content that is delivered as a video on demand for a single fee for a fixed period of viewing (# of hours). Content can be bought and stored to a user's device such as STB 108, personal computer 260, tablet 270, and the like where the content is received from content managers 205, 235. Other purchase, rental, and subscription options for content managers 205, 235 can be utilized as well.

Online social servers 240, 245 represent the servers running online social networks that communicate through broadband network 250. Users operating a consuming device such as STB 108, personal computer 260, tablet 270, and phone 280 can interact with the online social servers 240, 245 through the device, and with other users. One feature about a social network that can be implemented is that users using different types of devices (PCs, phones, tablets, STBs) can communicate with each other through a social network. For example, a first user can post messages to the account of a second user with both users using the same social network, even though the first user is using a phone 280 while a second user is using a personal computer 260. Broadband network 250, personal computer 260, tablet 270, and phone 280 are terms that are known in the art. For example, a phone 280 can be a mobile device that has Internet capability and the ability to engage in voice communications.

Turning now to FIG. 3, a block diagram of an embodiment of the core of a set top box/digital video recorder 300 is shown, as an example of a consuming device. The device 300 shown can also be incorporated into other systems including the display device 114. In either case, several components necessary for complete operation of the system are not shown in the interest of conciseness, as they are well known to those skilled in the art.

In the device 300 shown in FIG. 3, the content is received in an input signal receiver 302. The input signal receiver 302 can be one of several known receiver circuits used for receiving, demodulation, and decoding signals provided over one of the several possible networks including over the air, cable, satellite, Ethernet, fiber and phone line networks. The desired input signal can be selected and retrieved in the input signal receiver 302 based on user input provided through a control interface (not shown). The decoded output signal is provided to an input stream processor 304. The input stream processor 304 performs the final signal selection and processing, and includes separation of video content from audio content for the content stream. The audio content is provided to an audio processor 306 for conversion from the received format, such as compressed digital signal, to an analog waveform signal. The analog waveform signal is provided to an audio interface 308 and further to the display device 114 or an audio amplifier (not shown). Alternatively, the audio interface 308 can provide a digital signal to an audio output device or display device using a High-Definition Multimedia Interface (HDMI) cable or alternate audio interface such as via a Sony/Philips Digital Interconnect Format (SPDIF). The audio processor 306 also performs any necessary conversion for the storage of the audio signals.

The video output from the input stream processor 304 is provided to a video processor 310. The video signal can be one of several formats. The video processor 310 provides, as necessary a conversion of the video content, based on the input signal format. The video processor 310 also performs any necessary conversion for the storage of the video signals.

A storage device 312 stores audio and video content received at the input. The storage device 312 allows later retrieval and playback of the content under the control of a controller 314 and also based on commands, e.g., navigation instructions such as fast-forward (FF) and rewind (Rew), received from a user interface 316. The storage device 312 can be a hard disk drive, one or more large capacity integrated electronic memories, such as static random access memory, or dynamic random access memory, or can be an interchangeable optical disk storage system such as a compact disk drive or digital video disk drive. In one embodiment, the storage device 312 can be external and not be present in the system.

The converted video signal, from the video processor 310, either originating from the input or from the storage device 312, is provided to the display interface 318. The display interface 318 further provides the display signal to a display device of the type described above. The display interface 318 can be an analog signal interface such as red-green-blue (RGB) or can be a digital interface such as high definition multimedia interface (HDMI). It is to be appreciated that the display interface 318 will generate the various screens for presenting the search results in a three dimensional array as will be described in more detail below.

The controller 314 is interconnected via a bus to several of the components of the device 300, including the input stream processor 302, audio processor 306, video processor 310, storage device 312, and a user interface 316. The controller 314 manages the conversion process for converting the input stream signal into a signal for storage on the storage device or for display. The controller 314 also manages the retrieval and playback of stored content. Furthermore, as will be described below, the controller 314 performs searching of content, either stored or to be delivered via the delivery networks described above. The controller 314 is further coupled to control memory 320 (e.g., volatile or non-volatile memory, including random access memory, static RAM, dynamic RAM, read only memory, programmable ROM, flash memory, EPROM, EEPROM, etc.) for storing information and instruction code for controller 214. Further, the implementation of the memory can include several possible embodiments, such as a single memory device or, alternatively, more than one memory circuit connected together to form a shared or common memory. Still further, the memory can be included with other circuitry, such as portions of bus communications circuitry, in a larger circuit.

To operate effectively, the user interface 316 of the present disclosure employs an input device that moves a cursor around the display, which in turn causes the content to enlarge as the cursor passes over it. In one embodiment, the input device is a remote controller, with a form of motion detection, such as a gyroscope or accelerometer, which allows the user to move a cursor freely about a screen or display. In another embodiment, the input device is controllers in the form of touch pad or touch sensitive device that will track the user's movement on the pad, on the screen. In another embodiment, the input device could be a traditional remote control with direction buttons.

The creation and the functioning of the content selections made available on a user's virtual channel can come from a plethora of access methods (and sources) including live broadcasts, personal video recorder programming, video on demand sources, disc based sources, streamed content and the like. The programming lineup for the virtual channel can be dynamically populated used for programming that is available exclusively from broadcast sources. The lineup for the virtual channel likewise can use programming selections from any of these sources whether the programming is broadcasted in a live setting, is provided on demand, and/or is provided from a stored source. That is, the virtual channel can have programming from both real/broadcasted sources and content that is available on demand (streamed, played from a personal video recorder, storage device, and the like).

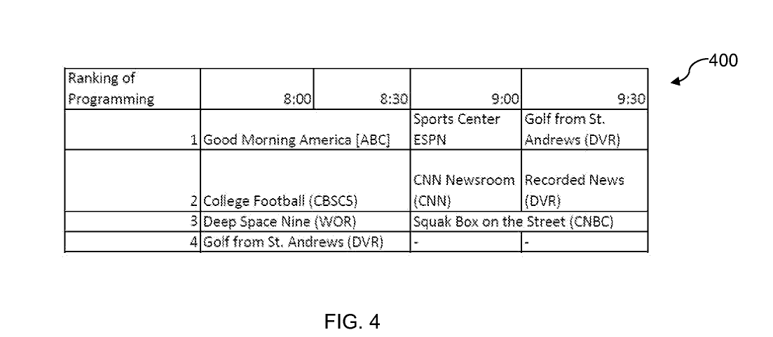

The programming selection can optionally be ranked where instead of having a user have to be pushed programming without the ability to select programming, the user can be presented with a list of programming options as shown in FIG. 4. The programming options are shown with time information, as well. That is, the presentation of information 400 in FIG. 4 accounts for various content that can come from both broadcasted and non-broadcasted (on demand content, recorded content on a storage medium, and the like). Optionally, the entries of ranked programming (the number of entries shown per time segment) can be set by a user.

### Profiling a User

In the creation of the content listing, as shown in FIG. 4, a user profile can be developed based on a particular user's interests that are determined from the content that a user has previously selected. A profile can be developed by taking into positive examples (content that a user typically accesses/watches) and negative examples (content that a user typically switches immediately or avoids completely). Specifically, a user's activity can be monitored by a monitoring software, hardware, or combination of hardware/software via set top box 108 (or other type of consumption device) or via a content manager 110 (e.g., a server) that records data related to the channel switching/flipping behavior a user has between channels. Such monitoring software can produce data taken at any time interview desired such as a number of seconds, minutes, hours, and the like.

The positive profile can be developed that if a user accesses particular content for over a threshold value tₘᵢₙ (such as a minute), the content is noted as being positive. Likewise, if a user accesses particular content for less than a minute, the content is noted as being negative.

### Profile Representation

A profile can then be developed as shown below:

Let:

P={p₁, p₂, . . . }—List of all programs, including personal video recorder, electronic program guide, and internet content.

S={s₁, s₂ . . . }—List of all seasons. |sⱼ|=># of programs in a season j.

Z={z₁, z₂, . . . }—List all series. |zₖ|=># of seasons in a series k.

dᵢ=Total duration of time program pᵢ was watched, excluding advertisements.

tₜ=Total duration of the program pᵢ, excluding advertisements.

vᵢ=Viewed time, instant pᵢ was viewed.

tₘᵢₙ—Parameter that sets a minimum view time threshold for dᵢ. A program viewed for less than this time is treated as a negative sample. A program viewed for more than this time is treated as a positive sample.

tₙₒᵢₛₑ=Parameter that sets a minimum view time. A program that is viewed for less than this time is considered not as being viewed.

A rating R for a program pᵢ can be calculated as follows:

Rₚᵢ={0, dᵢtₙₒᵢₛₑ}
{−5, tₙₒᵢₛₑ<dᵢ<tₘᵢₙ}
{2, tₘᵢₙ<dᵢ<tᵢ/2}
{3, tᵢ/2<dᵢ<7tᵢ/10}
{4, dᵢ>7tᵢ/10}
{5, repeat}

Note, a rating of −5 is a negative sample since the user was not interested in watching a program.

The following parameters are calculated if pᵢ is part of a series. A rating for a particular season sj is the mean of all watched programs and is calculated as follows:

Rₛⱼ=Σₚᵢ/|sⱼ|

A rating for a particular series zk is the mean of all of the seasons and is calculated as follows:

R_{zk}=ΣRₛᵢ/|zₖ|

The mean calculation shown above can be modified as needed. It is noted for calculating Rₛⱼ when there are few programs for a season that the ratings associated with the averages of the previous seasons of particular content can be linearly combined.

A list of previously viewed programs (PVL) that represents a user's interested to time can be calculated as:

PVL={(p₁, v₁, d₁), (p₂, v₂, d₂), . . . }

### Ranking Programs/Content

For each time slot for a virtual channel, a ranking of programming content can be calculated from a plurality of different content. Such a ranking can be calculated as follows:

t=The current time.

P^{t}—Programs that will be considered for inclusion in a particular time slot t.

For a program pᵢ in P^{t}, let zₖ be a corresponding series.

Note there can be multiple programs with the same zₖ. Also it is possible that some programs will not be part of any series. Ranking is done by considering that content is typically made available in a cyclic patterns, the consideration of content relevancy, and penalties (for negative examples).

For the discussion of selecting programs, it is noted that a viewed program/content can be a single television show/episode. Such episodes are typically associated with a season (for example, FRIENDS has unique episodes, yet each episode is part of a first/second/third season. Each season then would be make up a series. Hence, a ranked program/content can have related program/content where such programs come from the same series. This is to consider is that it is likely that user would not want to see information about a program that has been already viewed, but the same user would want to see information about related program in the same series. The term “related” can also mean that programming and related content have similar genres, actors, directors, from the same broadcaster, and the like. Suggested content can therefore be “related” because of these similarities between ranked content and the suggested other content.

### Capturing Periodic Patterns

Considering that a user can view content periodically or in various cycles (for example a television episode of a series is broadcasted and watched weekly or daily), a weight can be ascribed to this behavior when attempting to rank programming. The filtering of PVL values can also be performed as to not consider non-periodic programs (specials, one off sports events, etc.). For this possibility, one can break up a day into discrete segments (such as 30 minute blocks). If this performed, a single day would represent 48 segments (0-47, 0 representing 12:00 am and 47 representing 11:30 pm). Let gᵢ equal the time segment corresponding to vᵢ. In this example, the items in the PVL whose gᵢ is the same as a current time segment will be considered.

The PVL list can also be filtered by removing items when dᵢ<tₘᵢₙ. A new list, Filtered Previously Viewed List (FPVL) is created:

FPVL={(p₁,t_{,1},zₖ), . . . }, here, p₁εzₖ

For each program pᵢ fin P^{t}, the weight cᵢ depends on the frequency of occurrences of zₖ in FPVL, periodicity, nᵢ, and R_{zk}. Here, nᵢ can be calculated in several ways, for example by taking discrete Fourier transforms (DFT) and finding the maximum absolute value. For programs not part of a series, a weight of 0 is assigned.

Vector vᵢ=Vector view times corresponding to programs in zₖ=[vₙ|pₙεzₖ]

ηᵢ=max (abs(DFT(vector vᵢ−\hat{v}ᵢ))/max(vector vᵢ)

Finding ηᵢ using DFT is a standard technique, although other techniques can be used as well.

A new value F_{zk} represents the normalized frequency of zₖ in FPVL. This value is calculated as follows:

F_{zk}=(5.0*frequency of zₖ in FPVL)/(highest frequency series of FPVL)

c₁={α*F_{zk}*ηₗ+(1×α)*R_{zk}, if ∃zₖ and pᵢ [symbol] zₖ}
{0, otherwise}

Alpha can be varied to either give importance to cyclic patterns or to more highly rated programs, 0<α<1.

### Relevancy Based Rank

If it is determined that there are not many or any cyclic patterns of content viewing, content can still be ranked by using the following techniques. Ideally, these principles should be practiced if no zₖ value corresponds to a pᵢ, although these principles can be employed in other cases. With the lack of cyclic content access information, this approach considers the recent content watched/accessed by a user and computes a value based on the centroid of the recently watched programs. For this determination, a subset of PVL based on recently watched programs (for a selected time interval) is used. For example, the programs watched in the past hour and with a duration of viewing>tₘᵢₙ is one criteria that can be used, among many other criteria.

The centroid is calculated as the mean of all of the content feature vectors of each program in a recent program list. Essentially, these representations are created by extracting content metadata features from electronic program guide information (such as program description, actor information, and the like) and having such information represent a point in vector space.

C=centroid vector=MEAN ([f vₙ|tₙ is recent, dₙ>tₘᵢₙ])

rᵢ={5.0*(1−COSIM(C,pᵢ)), [symbol] zₖ}
{0, otherwise}

Here, COSIM ( ) is a standard function that calculates the similarity between two vectors.

Penalties

A factor Kₐ can also be used if a program has already been recorded and is available on demand using a device such as a personal video recorder, video on demand system, or disc player. Kₐ, is a modifiable parameter, −1<Kₐ<0.

Kₐ={0, if there is no repeat of pᵢ}
{Kₐ, otherwise}

A factor Kₗ can be used if a program is broadcasted in a new (different) time slot. Kₗ is a modifiable parameter, −1<K₁<0.

Kₗᵢ={0, if pᵢ was not on a recording device that records broadcasted programming}
{Kₗ, otherwise}

A factor K_{w} can be used if a program has been watched before. K_{w} represents a modifiable parameter, −1<K_{w}<0.

K_{wi}={0, if pᵢ was viewed before}
{K_{w}, otherwise}

The final predicted score/ranking for a program pᵢ is calculated:

Sₚᵢ=cᵢ+rᵢ+Kₐᵢ+Kₗᵢ+K_{wi}

All of the programs in a particular time slot in a the virtual channel are then ranked according to this score whereby a system will switch to the highest ranked program for a time slot by computing programming rankings for the time slot. This automatic switching is typically performed at the end of a program or when a user first selects the personal virtual channel. The actual switching between content can depend on how a program is accessed where for example broadcasted programming may only be available at a certain time versus programming which is stored on a personal video recorder and would be available on demand. Similar factors can be considered for disc based players, storage devices, and other sources of content.

When content is switched using the virtual channel, a listing of the programming details can be shown using a displayed message. In addition, the user can be shown the other suggested programming options that would be available at that time, as well. A user can also be presented with the option to switch back to a previously viewed content if a user does not like any of the newly presented options. When a user selects a particular program from the list of suggested programming from the virtual channel, rating value Rₚⱼ is set to 2.

Optionally, if a user is accessing a first piece of content and a second piece of content with a higher ranking begins, the user will be presented with a message that indicates that the second piece of content is starting. The user can also be notified via a message that the content with the higher ranking is a highly ranked selection for the user.

Another optional feature, which is user toggled, can provide a system which will have the content be switched to a new program pⱼ (second program) while in the middle of a program pᵢ (first program), if Sₚⱼ>K>K*Sₚᵢ where K>1.

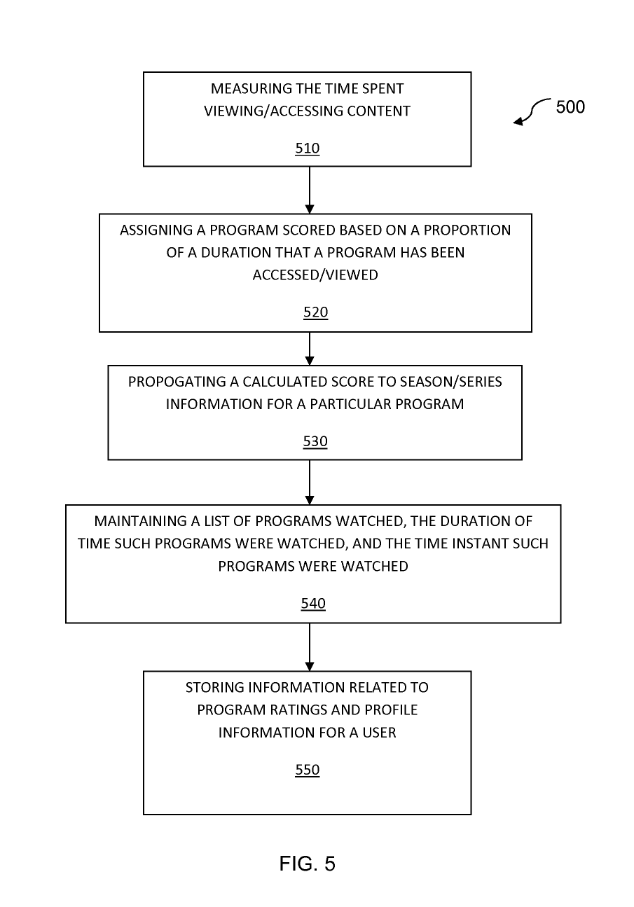

FIG. 5 represents a flow diagram for a method 500 for determining personalization metrics. The method begins with the calculation of the amount of time that a user spends accessing or watching content (510). The determination of this step can time values such as dᵢ, tᵢ, vᵢ, and the like. In step 520, a program score is determined which is based on the amount of time content/program is accessed/viewed which can be done using the various time values discussed in above in this specification.

Once a program score is determined, such information in step 530 is propagated to the corresponding season (S) and series (Z) that corresponds to the program/content (P), From such associations and from the application of the principles listed above, data representing the programs that were watched with the duration of time such programs were watched and the time instants when such programs were watched in calculated in step 540. The program related information (from the previous steps) is used for determining the program ratings information (550). The ranking information is eventually used for ranking the content used for the virtual channel (as in step 650).

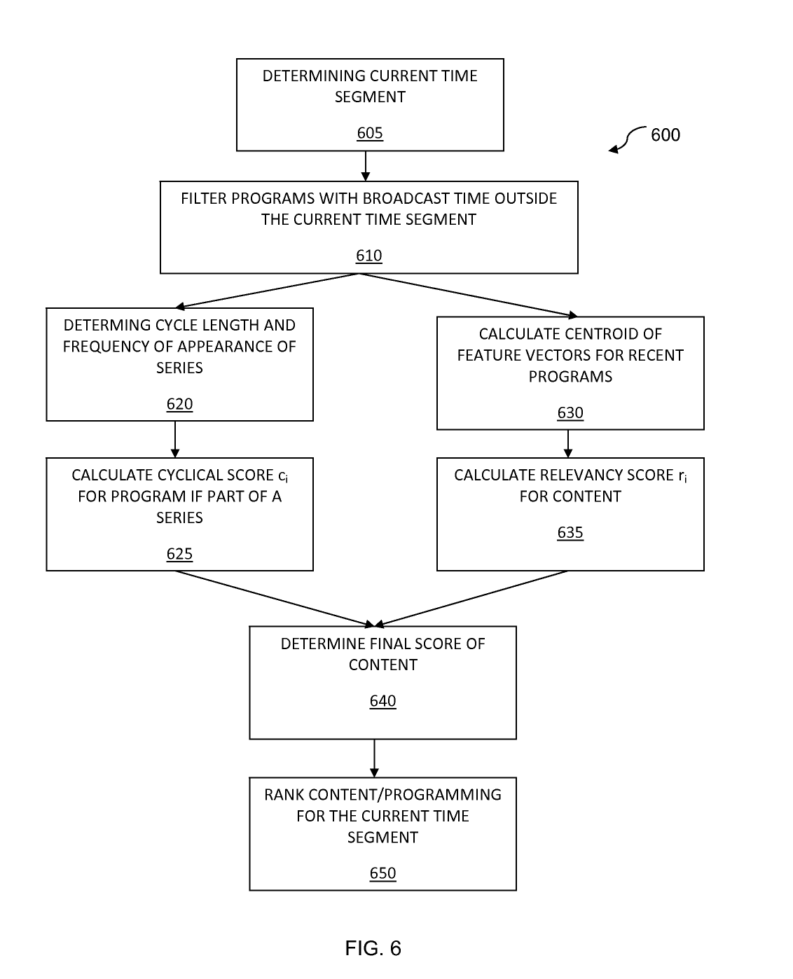

FIG. 6 represents a flow chart diagram for a method 600 for determining the content selected for a virtual channel for a particular time segment. A time segment, as mentioned above, can be a predetermined length of time which is typically half hour increments, although time segments can be broken into other lengths as well (any set of minutes, hours, days, and the like). In step 605, a current time segment (t) is determined. Once the time segment is determined, a filtering step 610 is performed which will filter out broadcast times outside the current time segment. This is to eliminate the display of consideration of content which will not be available for a current time. This filtering can affect both broadcasted content and non-broadcasted content (for example, some video on demand programming can be presented for a specific time window).

As discussed previously, the selection and ranking of content can be bifurcated into two paths: programming which occurs cyclically on a daily, weekly, monthly basis (steps 620,625) and programming which is not repeated as frequently, if not at all (steps 630, 635). In step 620, the information about the cycle length and the frequency of a series (which is determined from P, S, and Z information). From these various values, a cyclical score Cᵢ is determined in step 625.

Alternatively, in step 630, it is determined that programming and content selections do not have a cyclical pattern. One of way of determining this is when no zₖ values correspond to any pᵢ values. Hence, a centroid vector C is determined in step 630 in relation to currently viewed programs. That is, because content is not cyclical, an alternative approach is used for determining what programming which is not typically repeated can be used for creating a virtual channel. Step 635, uses the centroid vectors for determining a relevancy score rᵢ for a particular program.

Regardless of what values are used, in step 640 a score (Sₚᵢ) for a program is determined using the approaches listed above. Such a score can make use of the various penalty factors K. In step 650, the various content is ranked based on the particular score S that is associated with the program. Such content is then ranked for a particular time segment, as shown in FIG. 4 and can be optionally presented with other types of information, as described above.

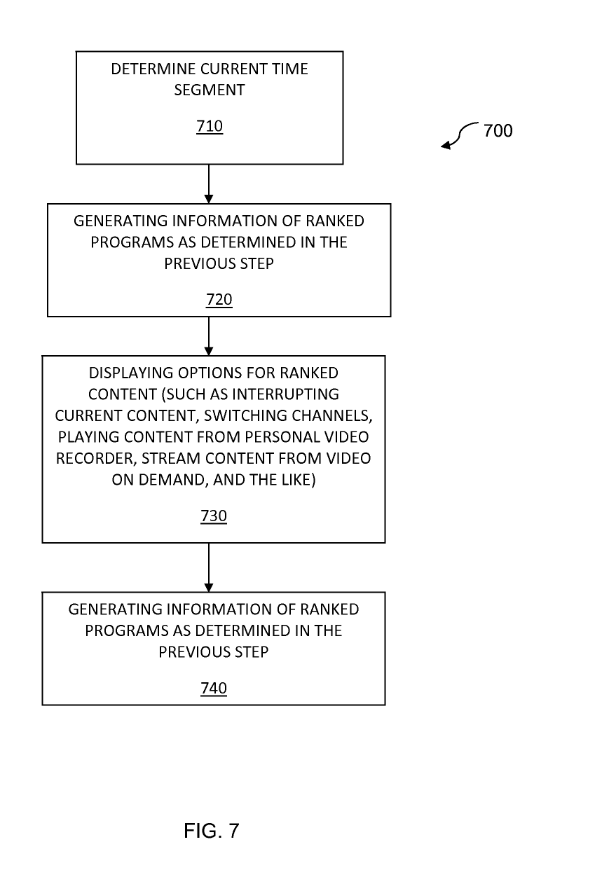

In the flow chart for FIG. 7, a method 700 is disclosed for determining and displaying ranked programming. In step 710, a time segment t is determined for listing ranked content selections. In step 720, the information generated from methods 500 and 600 can be used for getting a listing of programming which is ranked. In step 730, such ranked content is actually shown in various ways, as described above (changing the programming from first content to second content, asking a user if they want to change to new content, and the like). Additionally, ranked content selections can be shown in step 740 which are displayed in an electronic program guide format as shown in FIG. 4, in a listing which is overlaid over regular video, and in other manners which are apparent to one of the ordinary skill in the art.

What is claimed is:

1. A method that provides a listing of programs comprising:
determining content preferences for a user from information related to the consumption of at least one program;
recommending a first plurality of ranked content for a first time period from said determined content preferences where said first plurality of ranked content contains an episode of a series from a streaming content provider; and
recommending a second plurality of ranked content for a second time period from said determined content preferences where said second plurality of ranked content contains a second episode of said series from said streaming content provider where said second episode sequentially follows said episode.

2. The method of claim 1 additionally comprising including content broadcasted during said first and second time periods in said respective first and second plurality of ranked content.

3. The method of claim 1 additionally comprising including content stored on a personal video recorder in said first and second plurality of ranked content.

4. The method of claim 1 additionally comprising that said first and second plurality of ranked content are presented in an electronic program guide listing a time period on one axis and rankings on a second axis.

5. The method of claim 1 where a message is provided to said user that content of a higher ranking is starting when said user is accessing content of a lower ranking.

6. An apparatus that provides listing of programs comprising:
a processor;
a memory containing instructions that when executed by said processor perform the operations:
determining content preferences for a user from information related to the consumption of at least one program;
recommending a first plurality of ranked content for a first time period from said determined content preferences where said first plurality of ranked content contains an episode of a series from a streaming content provider; and
recommending a second plurality of ranked content for a second time period from said determined content preferences where said second plurality of ranked content contains a second episode of said series from said streaming content provider where said second episode sequentially follows said episode.

7. The apparatus of claim 6 additionally comprising including content broadcasted during said first and second time periods in said respective first and second plurality of ranked content.

8. The apparatus of claim 6 additionally comprising including content stored on a personal video recorder in said first and second plurality of ranked content.

9. The apparatus of claim 6 additionally comprising that said first and second plurality of ranked content are presented in an electronic program guide listing a time period on one axis and rankings on a second axis.

10. The apparatus of claim 6 where said processor executes an operation from said instructions of providing a message to said user that content of a higher ranking is starting when said user is accessing content of a lower ranking.
